(19) United States
(12) Patent Application Publication
(10) Pub. No.: US 2008/0149011 A1
(43) Pub. Date: Jun. 26, 2008

(54) Method and Device For the Thermochemical Conversion of a Fuel

(75) Inventors: Peter Quicker, Bamberg (DE); Gerold Dimaczek, Kuemmersburck (DE); Frank Fojtik, Georgenberg (DE)

Correspondence Address: KANESAKA BERNER AND PARTNERS LLP, 1700 DIAGONAL RD, SUITE 310, ALEXANDRIA, VA, 22314-2848, US

(73) Assignee: Applikations- Und Technikzentrum, Suizbach-Rosenberg (DE)

(21) Appl. No.: 11/883,835

(22) PCT Filed: Jan. 28, 2006
(86) PCT No.: PCT/EP2006/000745

§ 371 Date: Sep. 13, 2007

(30) Foreign Application Priority Data
Feb. 9, 2005 (DE) 102005005796.9

(51) Int. Cl. F23C 10/00; F23C 10/22; F23C 10/24; F27B 15/00

(52) U.S. Cl. 110/245; 422/146; 110/341; 431/159

(57) ABSTRACT

The invention relates to a method for the thermochemical conversion of a fuel, comprising the following steps: a) provision of a fluidised-bed reactor with a central first combustion zone (1) and a second combustion zone (7) that is separated from the first by flow conduction means (2, 15), the first combustion zone (1) being provided with a supply opening (16) for supplying fuel and a unit (3), which lies opposite the supply opening (16) on the floor (B) of the fluidised bed reactor, for deviating a stream of fuel into the second combustion zone (7); b) feeding of fuel through the supply opening (16), so that a stream of fuel forms that is directed towards the floor (B); c) deviation of the stream of fuel on the floor (B) into the second combustion zone (7), so that the stream of fuel is guided in an essentially opposite direction; and d) additional deviation of the stream of fuel in the vicinity of the supply opening (16), causing the stream of fuel to be returned to the first combustion zone.

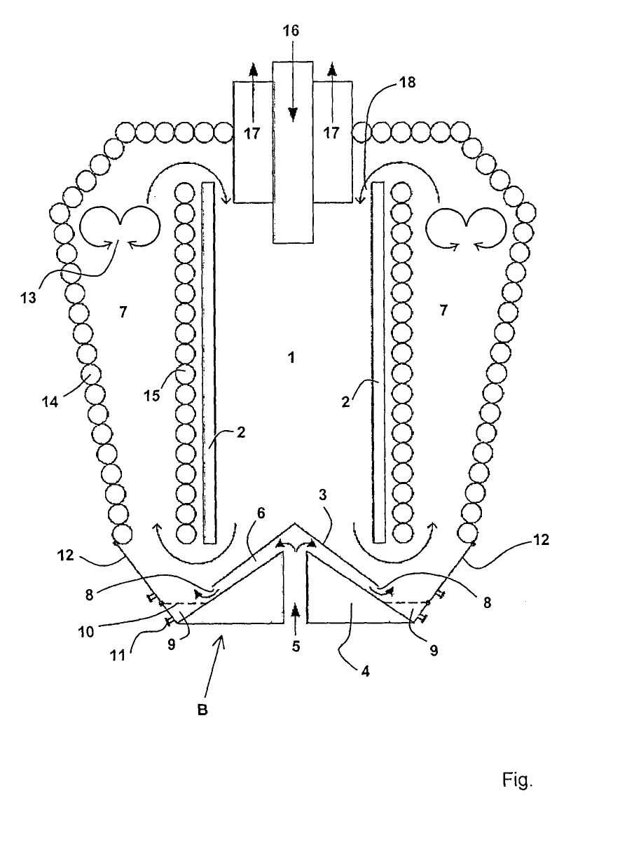

The invention relates to a method and a device for the thermochemical conversion of a fuel. It relates in particular to the field of fluidised bed combustion, in which the fuel is combusted in a fluidised bed which is formed by a circulating fluid.

A fluidised bed reactor is known from DE 39 24 723 C2, n which the fuel is supplied via a horizontal pipe which is located close to the floor and which extends into the reactor. The ash is removed through an additional horizontal pipe, which also opens into the reactor close to the floor. Disadvantageously, with the method proposed, only a non-continuous implementation of the method is possible. In particular, the method is not suitable for the combustion of fuels which contain a large quantity of ash.

U.S. Pat. No. 5,858,033 describes a fluidised bed reactor in which the fuel is supplied through a pipe which opens at the side in the upper section of the reactor. On the floor of the reactor, a ring-shaped nozzle arrangement is provided with which a circulating fluid current is generated. The ash which is produced during the combustion of the fluidised bed is removed via a ring gap on the floor of the reactor which surrounds the nozzle arrangement. Similar fluidised bed reactors are known from U.S. Pat. No. 5,980,858 and U.S. Pat. No. 5,922,090. Here, the ash is removed via a grid on the floor of the fluidised bed reactor. With the known fluidised bed reactors, the nozzles may become blocked and uncombusted fuel may be removed. DE 199 37 524 A1, DE 198 43 613C2, DE 198 06 318 A1 and DE 199 37 521 A1 describe methods for the combustion of by-products and waste materials from the paper industry. Here, the energy generated during the fluidised bed combustion is obtained from the exhaust gas by means of heat exchangers.

DE 197 14 593 A1, DE 199 03 510 C2, DE 35 17 987 C2, DE 690 00 323 T2 and DE 693 07 918 T3 describe fluidised bed reactors in which the combustion is conducted in a cylindrical reactor. Here, the heat is also generally obtained by means of heat exchangers which are switched in the exhaust gas flow.

DE 198 48 155 C1, DE 32 14 649 C3, DE 37 15 516 A1, DE 38 03 437 A1, DE 39 29 178 A1 and DE 696 18 819 T2 disclose fluidised bed reactors with which an inert material is supplied to the reactor in order to generate the fluidised bed.

The fluidised bed reactors known according to the prior art are generally designed for a high output range. They are not suitable in particular for the combustion of solid fuels which contain a large quantity of ash, such as biomass, in a low output range.

The object of the present invention is to provide a method and a device with which fuels can also be thermochemically converted in a low output range in a simple and cost-effective manner.

This object is attained by means of the features described in claims 1 and 18. Advantageous embodiments are described in the features in claims 2 to 17 and 19 to 34.

According to the invention, a method for the thermochemical conversion of a fuel is provided with the following steps:

a) Providing of a fluidised bed reactor with a central first combustion zone and a second combustion zone that is separated from the first combustion zone by flow conduction means, wherein the first combustion zone is provided with a supply opening for supplying fuel and a unit which lies opposite the opening on the floor of the reactor for deviating a stream of fuel into the second combustion zone,

b) feeding of fuel through the supply opening so that a stream of fuel forms that is directed towards the floor,

c) deviating of the stream of fuel on the floor into the second combustion zone so that the stream of fuel is guided in an essentially opposite direction,

d) further deviating of the stream of fuel in the vicinity of the supply opening, causing the stream of fuel to be returned to the first combustion zone.

With the method proposed according to the invention, the fuel is combusted in a fluidised bed reactor which is separated by flow conduction means into a first and a second combustion zone. This enables an enforced guidance of the fuel stream, and thus a particularly compact structure of the fluidised bed reactor. The proposed method is suitable in particular for the combustion of fuel in a low output range. In particular, the method is suitable for the combustion of solid fuels which contain a large quantity of ash, such as biomass.

According to an advantageous embodiment, ash which is produced during the thermochemical conversion is removed through removal openings which are provided in the floor. Means of closure can be provided in order to close the removal openings. Furthermore, it has been shown to be advantageous to separate the removal openings from the first and/or second combustion zone by means of a grid. This enables the method to be implemented continuously. Between the grid and the removal openings, an ash collection area can be provided, for example, which can be emptied discontinuously by opening the removal openings. Naturally, it is also possible, however, to continuously remove the ash which is produced through the removal openings.

According to a further embodiment, it is provided that during the thermochemical conversion, the exhaust gas which is formed is guided through at least one exhaust gas opening which is located close to the supply opening. This makes it possible to implement the method efficiently while requiring only little space.

Advantageously, a cross-sectional area of the second combustion zone increases at least in sections from the floor towards the supply opening. Around the large cross-sectional area, the speed of the stream is reduced. As a result, when a suitable stream speed is selected, a fluidised bed is formed, in which large particles spend a longer amount of time than small ones. Small particles, in particular fine ash particles are removed, while the large particles which contain fuel which is still usable are efficiently post-combusted. In this manner, a particularly efficient combustion of the fuel can be achieved.

The reactor according to the invention can be box-shaped. In this case, two second combustion zones are advantageously provided, which are arranged adjacent to the first combustion zone. However, it can also be the case that the second combustion zone surrounds the first combustion zone. In this case, the first combustion zone is cylindrical in form, for example.

According to a further embodiment, it is provided that the heat which is produced during the thermochemical conversion is removed by a heat exchanger, which at least partially surrounds the second combustion zone and/or is a component of the flow conduction means between the first and the second combustion zone. This makes possible a particularly effective utilisation of the energy released during the thermochemical conversion.

The heat exchanger can be at least partially protected from the first and/or the second combustion zone by a fire-resistant shield. The shield is advantageously made of a ceramic, fire-resistant material. It can take the form of a plate, a cylinder, a tapered cone or similar, depending on the design of the reactor. In particular, the fire-resistant shield can also be a component of the flow conduction means.

The thermochemical conversion can be a combustion or a gasification. Here, solid as well as fluid fuels can be converted in particular.

According to a further embodiment, the unit for diverting the fuel stream comprises a roof or cone-type diversion means. Furthermore, the unit for diverting the fuel stream can comprise nozzles for accelerating the fuel stream which is diverted using the diversion means in the direction of the second combustion zone. The nozzles can comprise a round, oval or slit-shaped opening. The fuel stream is advantageously accelerated by a fluid which is supplied via the nozzles. Here, the fluid can be ejected by the nozzles in a direction which points to the floor. This supports the enforced guidance of the fuel stream which is generated by the flow conduction means from the first combustion zone into the second combustion zone.

The fluid is advantageously a gas which is selected from the following group: air, inert gas, smoke gas or radiation-active gas. A radiation-active gas is considered to be a gas which enables a heat transfer with a particularly high heat flow density. In particular under high temperatures of over 900° C., a significant portion of the heat is transferred via radiation. With a radiation-active gas, the heat transfer can be effectively conducted by means of radiation. The radiation-active gas contains preferably 40% per weight of a triatomic gas, which can be one or more of the following gases, for example: CO₂, NH₃, H₂O, SO₂ or CH₄. The radiation-active gas can also be mixed with air.

Furthermore, the fluid can contain at least one additive from the following group; lime water, ammonia, urea, lime stone. Additives of this type contribute to a combustion of fuels which produces the lowest possible level of pollutants.

Advantageously, a unit is also provided for the pre-heating of the fluid. In this way, the combustion temperature can be set and/or controlled.

According to a further aspect of the invention, a device is provided for the thermochemical conversion of a solid fuel with a fluidised bed reactor with a central first combustion zone and a second combustion zone which is separated from this by flow conduction means, whereby the first combustion zone is provided with a supply opening for the supply of fuel and a unit which lies opposite the supply opening on the floor of the reactor for deviating a stream of fuel into the second combustion zone, so that a fuel stream which is directed towards the floor is diverted into the second combustion zone, is guided in an essentially opposite direction, and is again diverted in the vicinity of the supply opening and guided back into the first combustion zone.

The device proposed is compact in its construction and enables an efficient thermochemical conversion of fuels even within a low output range. Due to the advantageous designs of the device, a reference is made to the present embodiments. The features described are also suitable in principle as a further embodiment of the device.

An exemplary embodiment of the invention will now be described in greater detail below with reference to the single drawing.

With the fluidised bed reactor shown in the single FIGURE, a first combustion zone 1 is restricted at its side by plates 2 which are made of a fire-resistant material, such as aluminium oxide, magnesium oxide, zircon oxide or similar. On the floor B of the fluidised bed reactor, a diversion unit 3 is provided. The diversion unit 3 is designed as a roof or saddle, whereby the roof surfaces or saddle flanks drop down from the centre of the fluidised bed reactor towards its sides in the direction of the floor B. The diversion unit 3 can be made of a temperature-resistant metal or equally from a fire-resistant ceramic material. Below the diversion unit 3, a fluid supply unit 4 is provided, which comprises a supply pipe 5 and nozzles 6. The nozzles 6 are arranged in such a manner that a fluid which is guided through is guided at an angle in the direction of a section of the floor B, which is located approximately below a second combustion zone 7. The nozzles 6 are restricted by the diversion unit 3, which is preferably made of a metal. When the fluidised bed reactor is operated, the diversion unit 3 heats up. As a result, the fluid which is guided through the nozzles 6 is also pre-heated. Instead of the supply pipe 5, a supply shaft or supply channels can be provided in the supply unit 4, which are in particular arranged in such a manner that a further pre-heating of the fluid is thus achieved. The second combustion zone 7 is arranged adjacent to the first combustion zone 1. The fluid can in particular be a gas, such as air, inert gas or a radioactive gas. The nozzles 6 advantageously open out in the area of the lower end of the diversion unit 3. The nozzle openings which are labelled with the reference numeral 8 can be slit-shaped, oval or round.

Approximately below the second combustion zone 7, the ash collection zones 9 are located, which are covered with grids 10. In the area of the ash collection zones 9, removal openings 11 for removing the ash are also provided. The removal openings 11 are advantageously located below the flaps 12. When the flaps 12 are opened, the interior of the fluidised bed reactor is easily accessible for maintenance and cleaning purposes. Instead of the flaps 12, other means of closure can naturally also be provided, which enable recurrent access to the interior of the fluidised bed reactor.

A cross-section area of the second combustion zone 7 which runs parallel to the floor B increases in size until it reaches an auxiliary fluidised bed zone which is labelled with reference numeral 13.

The walls of the second combustion zone 7 are provided with an external heat exchanger 14 and an internal heat exchanger 15. Like the plate 2, the internal heat exchanger 15 functions as a flow conduction means, and separates the first combustion zone 2 from the second combustion zone 7.

Opposite the diversion unit 3, a supply opening 16 for supplying fuel and two exhaust gas openings 17 for removing exhaust gas are located in the upper section of the fluidised bed reactor. Between the exhaust gas openings 17 and the plates 2, there is a gap or opening 18 which enables the fuel stream which originates from the second combustion zone 7 to enter the first combustion zone 1.

The mode of functioning of the fluidised bed reactor is as follows: fuel, such as biomass, which is guided through the supply opening 16 is guided in the first combustion zone 1 in the direction of the diversion unit 3, and is combusted in the process. The fuel stream which is directed towards the diversion unit 3 is split by means of the diversion unit 3 into two partial streams, and is diverted in the direction of the second combustion zone 7. In order to maintain the stream, air is blown through the supply pipe 5, for example, which is emitted at the nozzle openings 8 and which accelerates the partial streams, so that they are directed upwards in the opposite direction in the second combustion zones 7. As a result of the cross-section area enlargement in the second combustion zone 7, the speed of the flow is reduced. In an upper section, auxiliary fluidised bed zones 13 are formed. In the auxiliary fluidised bed zones 13, larger fuel particles which have not yet been fully combusted are separated from the fine material until they have achieved a certain degree of fineness due to the combustion. Finer ash particles are in contrast immediately transported onwards and are removed from the circulating fuel stream via the exhaust gas openings 17.

The heat which is produced during combustion in the combustion zones 1 and 7 is extracted by means of the heat exchangers 14, 15, and can then be used at another location for energy generation, heating or similar. The fluid which is guided through the supply pipe 5 can be pre-heated by means of fluid channels which are provided in the floor B and/or in the diversion unit 3 along the nozzle 6. This makes it possible to adjust or control the combustion temperature.

Large ash particles are collected in the ash collection zones 9 and guided out via the removal openings 11, preferably continuously.

The present invention is not restricted solely to the exemplary embodiment described. Other types of fluidised bed reactor can also be used in order to implement the method according to the invention. For example, the first combustion zone 1 can also be cylindrical and the second combustion zone 7 can be designed as a ring gap which surrounds the first combustion zone 1. Similarly, the exhaust gas opening 17 can also be designed as a ring gap which surrounds the supply opening 16. With a cylindrical design, the diversion unit 3 can be cone or dome-shaped. The arrangement of the nozzles 6 is selected in such a manner that an optimum circulation of the fuel is guaranteed by the first 1 and the second combustion zone 7. A speed of the circulating fuel stream can be adjusted depending on the geometry of the second combustion zone 7 in such a manner that advantageous auxiliary fluidised bed zones 13 are formed there.

### LIST OF REFERENCE NUMERALS

1 First combustion zone
2 Plate
3 Diversion unit
4 Fluid supply unit
5 Supply pipe
6 Nozzle
7 Second combustion zone
8 Nozzle opening
9 Ash collection zone
10 Grid
11 Removal opening
12 Flap
13 Auxiliary fluidised bed zone
14 External heat exchanger
15 Internal heat exchanger
16 Supply opening
17 Exhaust gas opening
18 Gap
B Floor

1-34. (canceled)

35. A method for the thermochemical conversion of a fuel having the following steps:
a) Providing of a fluidised bed reactor with a central first combustion zone (1) and a second combustion zone (7) that is separated from the first combustion zone (1) by flow conduction means (2, 15), wherein the first combustion zone (1) is provided with a supply opening (16) for supplying fuel and a unit which is provided opposite the opening (16) at the floor (B) of the reactor for deviating a stream of fuel into the second combustion zone (7),
b) feeding of fuel through the supply opening (16) so that a stream of fuel forms that is directed towards the floor (B),
c) deviating of the stream of fuel on the floor (B) into the second combustion zone (7) so that the stream of fuel is guided in an essentially opposite direction and is accelerated by means of nozzles (6) in the direction of the second combustion zone (7), wherein as a result of the at least sectional enlargement of the cross-sectional area of the second combustion zone (7) from the floor (B) in the direction of the supply opening (16), the speed of the stream of fuel is reduced around the large cross-section area in such a manner that an auxiliary fluidised bed zone (13) is formed in the second combustion zone (7), and
d) further deviating of the stream of fuel in the vicinity of the supply opening (16), causing the stream of fuel to be returned to the first combustion zone.

36. A method according to claim 35, wherein the ash which is produced during the thermochemical conversion is removed via removal openings (11) on the floor (B).

37. A method according to claim 35, wherein means of closure are provided in order to close the removal openings (11).

38. A method according to claim 35, wherein the removal openings (11) are separated from the first (1) and/or the second combustion zone (7) by means of a grid (10).

39. A method according to claim 35, wherein exhaust gas produced during the thermochemical conversion is removed via at least one exhaust gas opening (17) which is situated in the vicinity of the supply opening (16).

40. A method according to claim 35, wherein the second combustion zone (7) surrounds the first combustion zone (1).

41. A method according to claim 35, wherein the heat which is produced during the thermochemical conversion is removed by means of a heat exchanger (14, 15), which at least partially surrounds the second combustion zone (7) and/or is a component of the flow conduction means which is provided between the first (1) and the second combustion zone (7).

42. A method according to claim 35, wherein the heat exchanger (14, 15) is at least partially protected from the first (1) and/or the second combustion zone (7) by a fire-resistant shield (2).

43. A method according to claim 35, wherein the thermochemical conversion is a combustion or a gasification.

44. A method according to claim 35, wherein the device (3) for diverting the fuel stream comprises roof-shaped or cone-shaped diversion means.

45. A method according to claim 35, wherein the fuel stream is accelerated by means of the fluid which is supplied via the nozzles (6).

46. A method according to claim 35, wherein the fluid is ejected via the nozzles (6) in a direction which points to the floor (B).

47. A method according to claim 35, wherein the fluid is at least one gas selected from the following group: air, inert gas, smoke gas or radiation-active gas.

48. A method according to claim 35, wherein the fluid contains at least one additive selected from the following group: calcium milk, ammoniac, urine, chalk.

49. A method according to claim 35, wherein a device for pre-heating the fluid is provided.

50. A device for the thermochemical conversion of a solid fuel with a fluidised bed reactor with a central first combustion zone (1) and a second combustion zone (7) which is separated from this by flow conduction means (2, 15), wherein the first combustion zone (7) is provided with a supply opening (16) for the supply of fuel and a unit (3) which is provided opposite the supply opening (16) at the floor (B) of the reactor for deviating a stream of fuel into the second combustion zone (7), so that a fuel stream which is directed from the supply opening (16) towards the floor (B) is diverted into the second combustion zone (7), is guided in an essentially opposite direction, and is again diverted in the vicinity of the supply opening (16) and guided back into the first combustion zone (1),
characterized in that
the unit (3) for diverting the fuel stream comprises nozzles (6) for accelerating the fuel stream which is diverted by the diversion means in the direction of the second combustion zone (7), and that
a cross-sectional area of the second combustion zone (7) is enlarged at least in sections from the floor (B) in the direction of the supply opening (16), the speed of the stream of fuel is reduced around the large cross-sectional area in such a manner that an auxiliary fluidised bed zone (13) is formed in the second combustion zone (7).

51. A device according to claim 50, wherein on the floor (B), removal openings (11) are provided for the removal of the ash produced during the thermochemical conversion.

52. A device according to claim 50, wherein means of closure are provided for the closure of the removal openings (11).

53. A device according to claim 50, wherein the exhaust gas openings (11) are separated from the first (1) and/or the second combustion zone (7) by a grid (10).

54. A device according to claim 50, wherein in the vicinity of the supply opening (16), at least one exhaust gas opening (17) is provided for the removal of the exhaust gas produced during the thermochemical conversion.

55. A device according to claim 50, wherein the second combustion zone (7) surrounds the first combustion zone (1).

56. A device according to claim 50, wherein a heat exchanger (14, 15) is provided for the removal of the heat which is produced during the thermochemical conversion, which at least partially surrounds the second combustion zone (7) and/or is a component of the flow conduction means which lies between the first (1) and the second combustion zone (7).

57. A device according to claim 50, wherein the heat exchanger (14, 15) is at least partially protected from the first (1) and/or the second combustion zone (7) by a fire-resistant shield (2).

58. A device according to claim 50, wherein the thermochemical conversion is a combustion or a gasification.

59. A device according to claim 50, wherein the unit (3) for diverting the fuel stream comprises roof-shaped or cone-shaped diversion means.

60. A device according to claim 50, wherein the fuel stream is accelerated by fluid which is supplied via the nozzles (6).

61. A device according to claim 50, wherein the nozzles (6) are arranged in such a manner that their emission direction points to the floor (B).

62. A device according to claim 50, wherein the fluid is at least one gas selected from the following group: air, inert gas, smoke gas or radiation-active gas.

63. A device according to claim 50, wherein the fluid contains at least one additive from the following group: lime water, ammonia, urea, lime stone.

64. A device according to claim 50, wherein a device for pre-heating the fluid is provided.
